(19) United States
(12) Patent Application Publication
(10) Pub. No.: US 2010/0043845 A1
(43) Pub. Date: Feb. 25, 2010

(54) Dishwasher with a rinse container and a drying arrangement

(75) Inventors: Helmut Jerg, Giengen (DE); Kai Paintner, Adelsried (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/229,346

(22) Filed: Aug. 21, 2008

(30) Foreign Application Priority Data
Aug. 20, 2008 (DE) 10 2008 038 503.4

(51) Int. Cl. B08B 3/10

(52) U.S. Cl. 134/105; 134/115 R

(57) ABSTRACT

In a dishwasher (GS) with at least one washing compartment (SB) and at least one drying facility (TE) for drying cleaned items, which has at least one sorption container (SOR) for holding reversibly dehydratable sorption material, in particular zeolite (ZEO), and with at least one connecting duct (VK) for conducting air being connected to the washing compartment (SB) to create an exchange of air between the washing compartment (SB) and the sorption container (BEH), reversibly dehydratable sorption material for absorbing an amount of moisture transported by the exchange of air is provided in the sorption container (BEH). The reversibly dehydratable sorption material is provided with a weight amount such that the amount of moisture absorbed by the sorption material is less than the amount of liquid applied to the items to be washed, in particular the amount of liquid applied in a rinsing step.

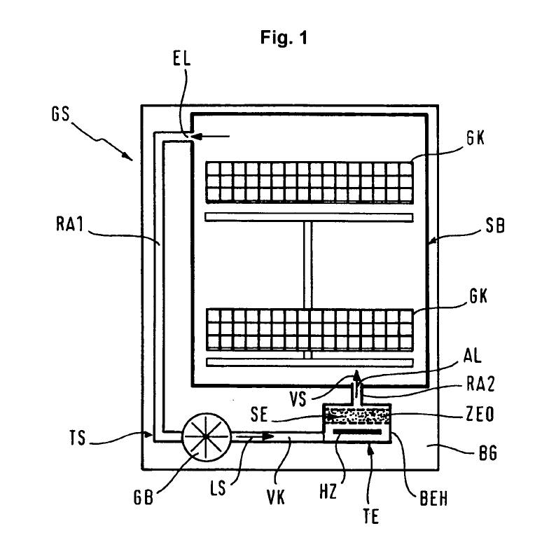

The present invention relates to a dishwasher, with at least one washing compartment and at least one drying facility for drying cleaned items, with the drying facility having at least one sorption container for holding reversibly dehydratable sorption material, in particular zeolite, and with at least one air duct for conducting air between the drying facility and the washing compartment for creating an exchange of air between the washing compartment and the sorption container.

Dishwashers with a so-called sorption column for the drying of dishes are known from DE VK 53 774 A1, DE VK 53 775 A1 or DE 10 2005 004 A1 for example. In these inventions moist air is directed out of the washing compartment of the dishwasher through the sorption column by means of a fan in the “drying” sub-program step of the respective dishwashing program of the dishwasher for drying dishes and moisture is removed by condensation through its reversibly dehydratable drying material from the air passing through the column. For regeneration, i.e. desorption of the sorption column, its reversibly dehydratable drying material is heated up to very high temperatures. This causes water stored in this material to escape as hot water vapor and it is directed by an air flow created by means of the fan into the washing compartment. Washing solution and/or dishes contained in the washing compartment as well as the air located in the washing compartment can be heated up by this process. This type of sorption column has proved to be very advantageous for an energy-saving and quiet drying of the dishes. In DE 10 2005 004 A1 for example, to prevent local overheating of the drying material during the desorption process, a heater is arranged in front of the air inlet of the sorption column in the direction of flow of the air. Despite this “air heating” during desorption it remains difficult in practice always to dry out the reversibly dehydratable drying material sufficiently and without problems.

The object of the invention is to achieve a further improvement in the sorption and/or desorption result for the reversibly dehydratable drying material of the sorption unit of a sorption drying device.

This object is achieved for a dishwasher of the type specified at the outset in that reversibly dehydratable sorption material for absorbing an amount of moisture transported by the exchange of air is provided in the sorption container with a weight amount such that the amount of moisture absorbed by the sorption material is less than the amount of liquid applied to the items to be washed, in particular the amount of liquid applied in the rinsing step.

Because the sorption material in the sorption container is matched in respect of its weight amount such that it merely absorbs part of the overall amount of the liquid which is smaller than the overall amount of liquid applied to the dishes, by using a small amount of sorption material an efficient capture of moisture in the air is enabled. This allows a compact design for the sorption container.

At the same time this ensures that the energy expended for complete regeneration of the sorption material by heating it up using a heater can be reduced, since only an amount of sorption material sufficient, matched or dimensioned for perfect drying of the items to be washed is heated up.

In accordance with a first expedient development of the invention the reversibly dehydratable sorption material is expediently provided with a weight amount in the sorption container such that the amount of moisture absorbed by the reversibly dehydratable sorption material essentially corresponds to the wetting amount with which the items to be washed are wetted after the end of the rinsing step. In such cases the wetting amount in particular involves the amount of liquid which, after the ending of a rinsing step, in which water mixed with surfactants was applied to the already cleaned items, adheres to the items to be washed, to the racks for holding the items to be washed and/or to the inner walls of the washing compartment and does not run down under the effects of gravity to the floor of the washing compartment. This matching of the weight amount of the sorption material is achieved by its capacity to take up moisture being sufficient to be able to largely completely capture or absorb this wetting amount in the sorption material by means of the exchange of air.

Preferably the sorption material is accommodated in the sorption container with a weight amount such that the absorbed amount of moisture corresponds to between 4 and 25%, in particular 5 to 15%, of the amount of liquid applied to the items to be washed.

In an advantageous manner a weight amount of between 0.2 and 5 kg, in particular between 0.3 and 3 kg, preferably between 0.5 and 2.5 kg, of reversibly dehydratable sorption material is present in the sorption container.

In accordance with one expedient embodiment the sorption container can be accommodated in a floor module below the floor of the washing compartment. This allows a sufficient quantity of sorption material to be accommodated in the dishwasher in a compact manner, so that no space is lost in the area of the side walls of the washing compartment. The interior and exterior dimensions can thus remain largely unchanged.

In accordance with an expedient embodiment the drying facility can be connected via at least one air duct to at least one outlet and to at least one inlet of the washing compartment. This allows an air circulation in the closed circuit.

In particular it can be expedient for the air duct to be largely arranged outside the washing compartment so that the useable space in the washing compartment is preserved, i.e. not reduced.

In particular there can be provision for the outlet-side tube section of the air duct to be connected to at least one inlet of the washing compartment in an area close to its floor. This is expedient if the sorption container is accommodated in the floor module of the dishwasher. In this way the outflow path for the dried air from the sorption container up to its inflow into the washing compartment of the dishwasher can be kept short, so that undesired heat losses are largely prevented.

In particular there can be provision for the inlet-side tube section of the air duct to be connected to at least one outlet of the washing compartment above its floor, in particular in the area close to its roof. This largely prevents spray water from a spray facility in the washing compartment being able to penetrate into the inlet opening of the inlet-side tube section of the air duct, e.g. during the cleaning or rinsing process or during the intermediate washing process. This would otherwise lead to an undesired partial or complete saturation of and damage to the sorption material and make this partly or entirely unusable for drying out moist air from the washing compartment.

Furthermore it may possibly be advantageous for the inlet-side tube section of the air duct to open out into the sorption container of the drying facility in such a way in the area close to the floor that its inflow direction is diverted, in particular by around 90°, into the preferably vertical throughflow direction of the sorption container. On the one hand this allows the moist air from the washing compartment to be routed via at least one inlet-side tube section of the air duct, which is arranged on a side wall and/or rear wall of the washing compartment. On the other the outlet-side tube section of the air duct between the output opening of the sorption container and the inlet opening of the washing compartment can run largely in a straight line and be kept comparatively short. In this way heat losses, in particular during the desorption of the sorption material are largely prevented, since the air heated up during desorption which is leaving the sorption container can flow into the washing compartment largely without path loss, i.e. directly. The efficiency of the sorption drying facility is improved in this way, in particular during desorption.

In accordance with a further expedient development, viewed in the flow direction of the air flow, at least one fan for creating the air flow can be provided in front of the drying facility. This allows a particularly effective forced flow of air onto the sorption material.

In accordance with a further expedient development, viewed in the direction of flow, at least one assigned heating element can be provided for desorption between the fan and the drying facility. This enables the sorption material to be regenerated, making it available again for the next dishwashing process for drying the items to be washed.

It can in particular be worthwhile for at least one heating element to be provided, viewed in the direction of flow, in the sorption container in front of its sorption unit with the reversibly dehydratable sorption material as a component of the sorption container for desorption of said material. This provides heating of the air, i.e. hot air can flow largely evenly through the sorption material. In this way so-called “hot spots”, i.e. local overheating points in the fill volume of the sorption material are largely prevented.

In accordance with an expedient development the drying device has at least one sorption unit with reversibly dehydratable drying material, in particular a solid bed of zeolite or a loose zeolite layer. A loose zeolite layer is in particular embodied by loose zeolite granulate, preferably in the form of small balls. The drying material or sorption material is preferably accommodated with largely the same layer thickness in a container or housing of the sorption unit. The container of the sorption unit is preferably delimited or covered in each case at its air inlet opening and/or air outlet opening with a sieve. This makes it possible in a practicable manner to provide a compact storage facility for the sorption material with simultaneous adequate throughflow of air, so that the sorption material can absorb sufficient moisture from air flowing through it by condensation and can also output or desorb stored moisture again by heating up air flowing through it.

Other developments of the invention are reproduced in the subclaims.

The invention and its developments are explained in greater detail below with reference to a single FIGURE:

The single FIGURE shows a schematic diagram of a dishwasher GS with a washing compartment SB and a sorption drying system TS. This is preferably provided externally, i.e. outside the washing compartment SB of the dishwasher GS. As its main components, it includes an air duct VK, at least one blower or fan GB as well as a drying facility TE. Accommodated in the washing compartment SB is/are for example one or more baskets GK for holding and washing dishes. The drying facility TE is connected via the air duct VK to at least one outlet EL and at least one inlet AL of the washing compartment SB. In this case the air duct VK is arranged largely outside the washing compartment SB. Specifically the inlet-side tube section RA1 of the air duct VK is connected to the outlet EL of the washing compartment SB in the area close to its roof. The outlet-side tube section RA2 of the air duct VK leads to the inlet AL of the washing compartment SB in the area close to its floor. In this way air from within the washing compartment SB can be fed via the air duct VK to the drying facility TE, e.g. during a drying stage of a dishwashing program and be fed dried from this back into the washing compartment SB, i.e. can circulate through the sorption drying system TS. The air inlet in the upper area of the washing compartment SB makes it largely possible to prevent water from the sump in the floor of the washing compartment or from its water spraying system (omitted from the FIGURE for reasons of clarity) getting into the air duct as well as into the sorption container BEH of the drying facility TE, which would otherwise make the sorption material impermissibly moist and unusable.

The drying facility TE is accommodated here in the exemplary embodiment in an advantageous manner in a floor module below the floor of the washing compartment SB. It is embodied as a so-called sorption column. This includes in the common housing or container BEH at least one heating element HZ and one sorption unit SE arranged downstream in the direction of flow, which is equipped with a reversibly dehydratable sorption material such as zeolite ZEO for example. The sorption unit in particular contains a solid bed of sorption material, preferably a solid zeolite bed, as a molecular sieve or a loose layer of sorption material, preferably a loose zeolite layer. A loose layer of sorption material, in particular a loose zeolite layer, is in particular embodied by loose granulate or other particles, preferably zeolite particles, preferably in the form of small balls. The dry material or sorption material is preferably accommodated as a multi-level layer with largely the same layer thickness in the container or housing BEH of the drying facility TE in the space between two sieves or mesh grids spaced from each other by a gap in the height direction which form the sorption unit SE. In this case the two sieves are arranged at a predeterminable distance in height from each other in parallel as well as covering one another in the horizontal planes. Each sieve in this case is essentially embodied as a flat or smooth surface. The two sieves are surrounded or enclosed around their outer circumference at their outer edges by the outer shell of the housing BEH as their outer limit. The sorption unit SE is thus arranged in the housing BEH in an essentially horizontal plane. In this way the sorption unit is delimited or covered at its air inlet opening and/or air outlet opening in each case by preferably at least one sieve or mesh, so that sorption material particles, in particular zeolite particles, are prevented from falling out of the container BEH of the sorption unit SE and simultaneously air can flow in through the interior of the sorption material from the air inlet opening to the air outlet opening with largely little flow resistance. The sorption unit preferably has a largely flat input-side inflow surface and a largely flat output-side outflow surface. In a practicable manner such a sorption unit makes possible a compact support of the sorption material with simultaneous sufficient ability to allow air to pass through, so that the sorption material for a sorption process can both sufficiently absorb moisture from the throughflow air by condensation and also for a desorption process for regeneration of the sorption material can output or desorb stored moisture again by heating up air flowing through it.

The housing BEH of the drying facility TE is shaped and positioned below the floor of the washing compartment GS such that air can flow through it in an essentially vertical direction. This means that it allows a draft direction through its integrated sorption unit SE from bottom to top. To guide the air the downstream end section of the inlet-side tube section RA1 of the air duct VK opens out into the housing BEH in the area of its housing base or housing floor. Here in the exemplary embodiment the downstream-side end section of the inlet-side tube section RA1 runs essentially in a horizontal plane to the base of the housing BEH. In this case it is essentially fitted close to below the floor of the housing BEH. It is coupled close to the floor to the housing BEH such that a flow directed in it is diverted from an originally approximately horizontal throughflow direction LS into an approximately vertical throughflow direction VS through the housing BEH, here by around 90°. Expressed in more general terms, a flow of air LS arriving in the inlet-side tube section RA1 is diverted from its original inflow direction in the area close to the floor or in the area of the chamber base of the housing BEH into its throughflow direction VS. The throughflow direction VS through the housing BEH is in this case in particular a flow direction which passes through the housing essentially in a straight line from the closed housing base to a roof-side outlet opening in the roof of the housing BEH, to which the upstream-side end section of the outlet-side tube section RA2 of the air duct GS is connected. With such a throughflow direction the horizontally-positioned layer with the sorption material in the sorption unit SE has an air flow forced or pushed through it in an essentially perpendicular direction.

For desorption of the reversibly dehydratable sorption material, in particular zeolite ZEO, of the sorption unit SE at least one heating element HZ is provided in close proximity before the inlet surface of the sorption unit SE in the housing BEH, in order to heat up air for the sorption material SE. In this case the heating element HZ is positioned in a plane before the inlet surface, which has a predeterminable gap from said surface to prevent local overheating of the sorption material at its input surface, and runs essentially parallel to the latter. The heating element HZ is preferably embodied by a heating rod or a heating filament. In particular the respective heating element HZ essentially extends over the entire clear width of the cross-sectional inlet surface of the sorption unit SE with the reversibly dehydratable drying material. This makes it possible to also heat up the air flow in the area of the longitudinal walls extending in the downward direction, i.e. in particular at the side edges, of the sorption unit SE in exactly the same way as in the center area of the cross-sectional width of the sorption unit SE. This largely prevents local moisture points in the drying material in particular in the area of the side walls of the sorption unit SE during desorption. If the width of the sorption unit SE essentially corresponds to the inner width of the housing BEH of the drying facility TE, the heating element HZ runs before the cross-sectional inlet surface of the sorption unit preferably essentially over the entire inner width of the housing BEH. In order to be able to heat up the cross-sectional inlet surface of the sorption unit SE for desorption of its sorption material amount over as full a surface as possible and thus largely homogeneously, so that local heating gaps in the sorption material volume are largely avoided, viewed in the downward direction of the sorption unit, in particular of the housing BEH, the heating element HZ is preferably laid in a serpentine or meandering shape. The meanderings of the heating element preferably run over the entire inner width of the sorption unit SE between the two side walls of the housing BEH to and fro in the downward direction. In particular the windings of the heating element HZ lie in approximately the same plane in this case.

To create a forced air flow through the air duct VK, viewed in the direction of flow, the fan GB is provided in the inlet-side tube section RA1 before the sorption unit SE of the sorption container BEH.

To summarize, the air duct VK, starting from the washing compartment GS, leads to the drying facility TE and from there back again into the washing compartment SB. The fan GB, with which air is sucked in from the washing compartment SB and blown back through the drying facility TE into the washing compartment, is arranged in front of the drying facility TE in the air duct VK. In the sorption container BEH of the drying device TE on the one hand the sucked-in air is dried, by the reversibly dehydratable sorption material to be found within it taking up moisture, and on the other hand the sorption material is dried again at specific time intervals with the aid of at least one heating element, i.e. dehydrated, in order to make it ready to absorb moisture from the air again.

Reversibly dehydratable sorption material, in particular zeolite ZEO, is advantageously provided in the sorption container BEH for sorption of an amount of moisture transported by the exchange of air with a weight amount such that the amount of moisture absorbed by the sorption material is less than the amount of liquid applied to the items to be washed, in particular the amount of liquid applied in a rinsing step. Because the sorption material in the sorption container BEH is matched in respect of its weight amount such that it merely absorbs part of the overall amount of the liquid which is smaller than the overall amount of liquid applied to the dishes, by using a small amount of sorption material an efficient capture of moisture in the air is enabled. This allows a compact design for the sorption container. At the same time this ensures that the energy expended for complete regeneration of the sorption material by heating it up using a heater can be reduced, since only an amount of sorption material sufficient, matched or dimensioned for perfect drying of the items to be washed is heated up.

In particular the reversibly dehydratable sorption material can expediently be provided with a weight amount in the sorption container such that the amount of moisture absorbed by the reversibly dehydratable sorption material essentially corresponds to the wetting amount with which the items to be washed are wetted after the end of the rinsing step. In such cases the wetting amount in particular involves the amount of liquid which, after the ending of the rinsing step, in which water mixed with surfactant was applied to the already cleaned items, adheres to the items to be washed, to the racks for holding the items to be washed and/or to the inner walls of the washing compartment and does not run down under the effects of gravity to the floor of the washing compartment. This matching of the weight amount of the sorption material is achieved by its capacity to take up moisture being sufficient to be able to largely completely capture or absorb up this wetting amount in the sorption material by means of the exchange of air.

Preferably the sorption material is accommodated in the sorption container with a weight amount such that the absorbed amount of moisture corresponds to between 4 and 25%, in particular 5 to 15%, of the amount of liquid applied to the items to be washed.

In an advantageous manner a weight amount of between 0.2 and 5 kg, in particular between 0.3 and 3 kg, preferably between 0.5 and 2.5 kg, of reversibly dehydratable sorption material is present in the sorption container.

1-13. (canceled)

14. A dishwasher comprising:
a washing compartment;
a drying facility for drying cleaned items comprising a sorption container for holding reversibly dehydratable sorption material having a weight such that an amount of moisture absorbed by the reversibly dehydratable sorption material is less than an amount of liquid applied to the items to be washed; and
an air duct conducting air between the drying facility and the washing compartment to create an exchange of air between the washing compartment and the sorption container

15. The dishwasher of claim 14, wherein the dehydratable sorpotion material comprises zeolite.

16. The dishwasher of claim 14, wherein the amount of liquid applied to the items to be washed is applied during rinsing.

17. The dishwasher of claim 16, wherein the weight of the reversibly dehydratable sorption material is such that an amount of moisture absorbed by the reversibly dehydratable sorption material corresponds to a wetting amount with which the items are wetted after the end of the rinsing.

18. The dishwasher of claim 14, wherein the amount of liquid applied to the items to be washed corresponds to between 4 and 25% of the amount of liquid applied to the items to be washed.

19. The dishwasher of claim 14, wherein the amount of liquid applied to the items to be washed corresponds to between 5 and 15% of the amount of liquid applied to the items to be washed.

20. The dishwasher of claim 14, wherein the weight amount of reversibly dehydratable sorption material is between 0.2 and 5 kg.

21. The dishwasher of claim 14, wherein the weight amount of reversibly dehydratable sorption material is between between 0.3 and 3 kg.

22. The dishwasher of claim 14, wherein the weight amount of reversibly dehydratable sorption material is between between 0.5 and 5 kg.

23. The dishwasher of claim 14, wherein the sorption container is in a floor module below of a floor of the washing compartment.

24. The dishwasher of claim 14, wherein the drying facility is connected via an air duct to an outlet and to an inlet of the washing compartment.

25. The dishwasher of claim 24, wherein the air duct is largely arranged outside the washing compartment.

26. The dishwasher of claim 14, wherein an outlet-side tube section of the air duct is connected to an inlet of the washing compartment in an area close to a floor of the washing compartment.

27. The dishwasher of claim 14, wherein an inlet-side tube section of the air duct is connected to an outlet of the washing compartment above a floor of the washing compartment.

28. The dishwasher of claim 27, wherein an inlet-side tube section of the air duct is connected to an outlet of the washing compartment close to a roof of the washing compartment.

29. The dishwasher of claim 14, wherein an inlet-side tube section of the air duct opens out into the sorption container of the drying facility in an area close to a floor such that its inflow direction is diverted by around 90°, into a through flow direction of the sorption container.

30. The dishwasher of claim 14, further comprising a fan for creating an air flow before the drying facility in a flow direction of the air flow.

31. The dishwasher of claim 30, further comprising an assigned heating element for desorption between the fan and the drying facility in a direction of flow.

32. The dishwasher of claim 14, wherein the sorption container comprises a heating element in front of a sorption unit in a direction of flow for desorption of the reversibly dehydratable sorption material.
